(19) United States
(12) Patent Application Publication
(10) Pub. No.: US 2007/0164922 A1
(43) Pub. Date: Jul. 19, 2007

(54) Antenna unit, method of controlling the same, and mobile device including the same

(75) Inventors: Dong-ho Rhee, Seoul (KR); Hyun-seok Choi, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/591,457

(22) Filed: Nov. 2, 2006

(30) Foreign Application Priority Data
Dec. 21, 2005 (KR) 2005-126941

(51) Int. Cl. H01Q 1/36

(52) U.S. Cl. 343/895; 343/729

(57) ABSTRACT

An antenna unit includes a first antenna; a second antenna receiving an electrical signal from the first antenna; and a frequency band transition unit interposed between the first antenna and the second antenna and transitioning between frequency bands receivable by the first antenna and the second antenna according to channels.

### CROSS-REFERENCE TO RELATED APPLICATION

This application claims the benefit of Korean Patent Application No. 2005-126941 filed on Dec. 21, 2005, in the Korean Intellectual Property Office, the disclosure of which is incorporated herein by reference in its entirety.

### BACKGROUND OF THE INVENTION

1. Field of the Invention

An aspect of the invention relates to an antenna, and more particularly to an antenna unit suitable for a mobile device capable of receiving broadcasting, a method of controlling the antenna unit, and a mobile device including an antenna unit having an optimized receive sensitivity.

2. Description of the Related Art

Antennas that receive a specific frequency band signal are designed to have an optimized receive sensitivity at a specific frequency band. The longer an antenna is, the wider the specific frequency band. The shorter an antenna is, the narrower the specific frequency band.

Mobile devices can receive broadcasting such as terrestrial digital multimedia broadcasting (TDMB), digital video broadcasting-handheld (DVB-H), or digital audio broadcasting (DAB). These mobile devices are too small to use long antennas. Therefore, these mobile devices use rod antennas or helical antennas.

Rod antennas or helical antennas can be used at a relatively low frequency band. However, these rod antennas or helical antennas are not long enough to have an optimized receive sensitivity. The mobile devices use Band III as designated by various countries or an ultra high frequency (UHF) band. Band III is 174˜240 MHz, and the UHF band is 420˜450 MHz.

The mobile devices must have their receive sensitivity optimized to an entire section of a used frequency band in order to provide an optimized receive sensitivity according to channels.

However, the rod antennas or helical antennas do not have an optimized receive sensitivity according to channels since they are too short to have specific frequency bands providing the optimized receive sensitivity.

Therefore, these mobile devices have different receive sensitivity according to channels. For example, if a mobile device capable has an optimized receive sensitivity at channel 12, the mobile device will have a receive sensitivity at channel 8 that is lower than the optimized receive sensitivity at channel 12.

### SUMMARY OF THE INVENTION

An aspect of the invention is to provide a short antenna unit having an optimized receive sensitivity according to channels.

Another aspect of the invention is to provide a method of controlling a short antenna unit to have an optimized receive sensitivity according to channels using a mobile device capable of receiving broadcasting.

Another aspect of the invention is to provide a mobile device having a short antenna unit having an optimized receive sensitivity according to channels.

According to an aspect of the invention, an antenna unit includes a first antenna; a second antenna receiving an electrical signal from the first antenna; and a frequency band transition unit interposed between the first antenna and the second antenna and transitioning between frequency bands receivable by the first antenna and the second antenna according to channels.

According to another aspect of the invention, an antenna unit includes a first antenna; a second antenna connected to the first antenna and receiving an electrical signal from the first antenna; a third antenna receiving an electrical signal from the second antenna; and a frequency band transition unit interposed between the second antenna and the third antenna and transitioning between frequency bands receivable by the first antenna, the second antenna, and the third antenna according to channels.

According to another aspect of the invention, a mobile device includes an antenna unit including at least two antennas, and a frequency band transition unit interposed between two of the at least two antennas and transitioning between frequency bands receivable by the antenna unit according to channels; a storage unit storing voltage values corresponding to the channels for use in controlling the antenna unit to transition between the frequency bands receivable by the antenna unit according to the channels; a controller outputting the voltage values corresponding to the channels based on the voltage values corresponding to the channels stored in the storage unit; and a digital/analog converter converting the voltage values corresponding to the channels output by the controller into analog voltage values corresponding to the channels and providing the analog voltage values corresponding to the channels to the antenna unit.

According to another aspect of the invention, the mobile device may further include a receive sensitivity measurer measuring a receive sensitivity of a signal received by the antenna unit while the digital/analog converter is providing one of the analog voltage values corresponding to one of the channels to the antenna unit, and providing the receive sensitivity of the signal to the controller; wherein the controller determines whether the receive sensitivity of the signal is optimized; and wherein if the controller determines that the receive sensitivity of the signal is not optimized, the controller repeatedly changes one of the voltage values corresponding to the one of the channels that was output by the controller and converted by the digital/analog converter into the one of the analog voltage values corresponding to the one of the channels and provides the changed voltage value to the analog/digital converter until the controller determines that the receive sensitivity of the signal is optimized.

According to another aspect of the invention, the mobile device may further include a receive sensitivity measurer measuring a receive sensitivity of a signal received by the antenna unit while the digital/analog converter is providing one of the analog voltage values corresponding to one of the channels to the antenna unit, and providing the receive sensitivity of the signal to the controller; wherein the controller determines whether the receive sensitivity of the signal is optimized based on a predetermined receive sensitivity; wherein if the controller determines that the receive sensitivity of the signal is not optimized, the controller repeatedly changes one of the voltage values corresponding to the one of the channels that was output by the controller and converted by the digital/analog converter into the one of the analog voltage values corresponding to the one of the channels and provides the changed voltage value to the analog/digital converter until the controller determines that the receive sensitivity of the signal is optimized or until the receive sensitivity measurer has measured the receive sensitivity of the signal a predetermined number of times to obtain a predetermined number of measured receive sensitivities, whichever comes first; and wherein if the controller has not determined that the receive sensitivity of the signal is optimized by a time the receive sensitivity measurer has measured the receive sensitivity of the signal the predetermined number of times, the controller sets an optimized receive sensitivity of the signal to be one of the predetermined number of measured receive sensitivities that is closest to the predetermined receive sensitivity.

According to another aspect of the invention, if a voltage value corresponding to the one of the channels being output from the controller and converted by the analog/digital converter into an analog voltage value at a time when the controller either determines that the receive sensitivity of the signal is optimized or sets the optimized receive sensitivity of the signal is different from a voltage value corresponding to the one of the channels stored in the storage unit, the controller changes the voltage value corresponding to the one of the channels stored in the storage unit to the voltage value corresponding to the one of the channels being output from the controller and converted by the analog/digital converter into an analog voltage value at the time when the controller either determines that the receive sensitivity of the signal is optimized or sets the optimized receive sensitivity.

According to another aspect of the invention, there is provided a method of controlling an antenna unit in a mobile device, the method including selecting a channel; and modifying a frequency band being received by the antenna unit based on a voltage value corresponding to the selected channel.

Additional aspects and/or advantages of the invention will be set forth in part in the description that follows and, in part, will be obvious from the description, or may be learned by practice of the invention.

### BRIEF DESCRIPTION OF THE DRAWINGS

The above and/or other aspects and advantages of the invention will become apparent and more readily appreciated from the following description of various embodiments, taken in conjunction with the accompanying drawings of which:

FIG. 1 shows an antenna unit according to an aspect of the invention;

FIGS. 2A through 2C show transitions between frequency bands received by the antenna unit shown in FIG. 1;

FIG. 3 shows an antenna unit according to another aspect of the invention;

FIG. 4 shows an antenna unit according to another aspect of the invention;

FIG. 5 is a block diagram of a mobile device including an antenna unit according to an aspect of the invention;

FIG. 6 is a block diagram of a mobile device including an antenna unit according to another aspect of the invention;

FIG. 7 is a block diagram of a controller shown in FIG. 6;

FIG. 8 is a block diagram of a mobile device including an antenna unit according to another aspect of the invention;

FIG. 9 is a flowchart of a method of controlling an antenna unit according to an aspect of the invention; and

FIG. 10 is a flowchart of a method of controlling an antenna unit according to another aspect of the invention.

### DETAILED DESCRIPTION OF THE EMBODIMENTS

Reference will now be made in detail to various embodiments of the invention, examples of which are shown in the accompanying drawings, wherein like reference numerals refer to like elements throughout. The embodiments are described below in order to explain the invention by referring to the figures.

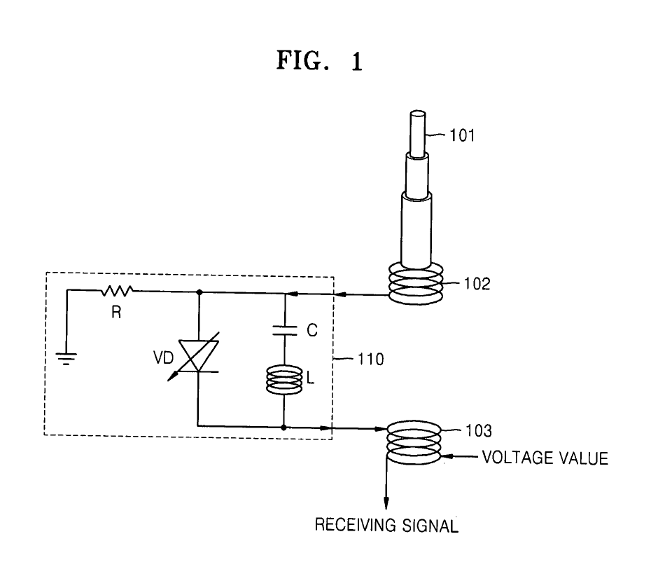

FIG. 1 shows an antenna unit according to an aspect of the invention. Referring to FIG. 1, the antenna unit includes a rod antenna 101, two helical antennas 102 and 103, and a frequency band transition unit 110 interposed between the two helical antennas 102 and 103.

The rod antenna 101 establishes a ground potential in a device including the rod antenna 101. The rod antenna 101 receives a radio wave, converts the radio wave into an electrical signal, and transfers the electrical signal to the helical antenna 102. A level of the electrical signal is measured relative to the ground potential established by the rod antenna 101.

The helical antenna 102 is a traveling-wave antenna formed of a helical wire. The helical antenna 102 is coupled to the bottom end of the rod antenna 101. The helical antenna 102 receives the electrical signal from the rod antenna 101, and transfers the electrical signal to the frequency band transition unit 110.

The frequency band transition unit 110 transitions between frequency bands receivable by the rod antenna 101 and the helical antennas 102 and 103 according to channels based on voltage values corresponding to the channels applied to the frequency band transition unit 110 via the helical antenna 103. The voltage values are different from one another according to the channels. Therefore, changing a voltage applied to the frequency band transition unit 110 via the helical antenna 103 causes the frequency band transition unit 110 to transition from one frequency band corresponding to one channel to another frequency band corresponding to another channel.

The frequency band transition unit 110 includes a resonance circuit including passive elements such as a capacitor C, an inductor L, a resistor R, and a varactor diode VD. In the resonance circuit shown in FIG. 1, the varactor diode VD is connected in parallel with a series connection of the capacitor C and the inductor L. The varactor diode VD has a capacitance that depends on a voltage applied across the varactor diode, and thus operates as a voltage-controlled capacitor. However, the resonance circuit is not limited to the configuration of the shown in FIG. 1, and other configurations can be used. For example, the varactor diode VD can be connected in parallel with only the inductor L, and the parallel connection of the varactor diode VD and the inductor L can be connected in series with the capacitor C. Also, the varactor diode VD can be replaced by any other suitable element having a capacitance that depends on a voltage applied across the element.

Values of the inductor L and/or the capacitor C connected in parallel with the varactor diode VD in the resonance circuit can be changed according to an operating condition of a mobile device or a frequency band covered by the mobile device. The resonance circuit resonates at a resonance frequency determined by characteristics of the elements of the resonance circuit and characteristics of the rod antenna 101 and the helical antennas 102 and 103, thereby enabling the antenna unit to receive frequency bands corresponding to the channels in response to the voltage values corresponding to the channels applied to the frequency band transition unit 110 via the helical antenna 103, which determine a voltage applied across the varactor diode VD. A change in a voltage value applied to the frequency band transition unit 110 via the helical antenna 103 changes the voltage applied across the varactor diode VD, which changes a capacitance of the varactor diode VD, which changes the resonance frequency of the resonance circuit.

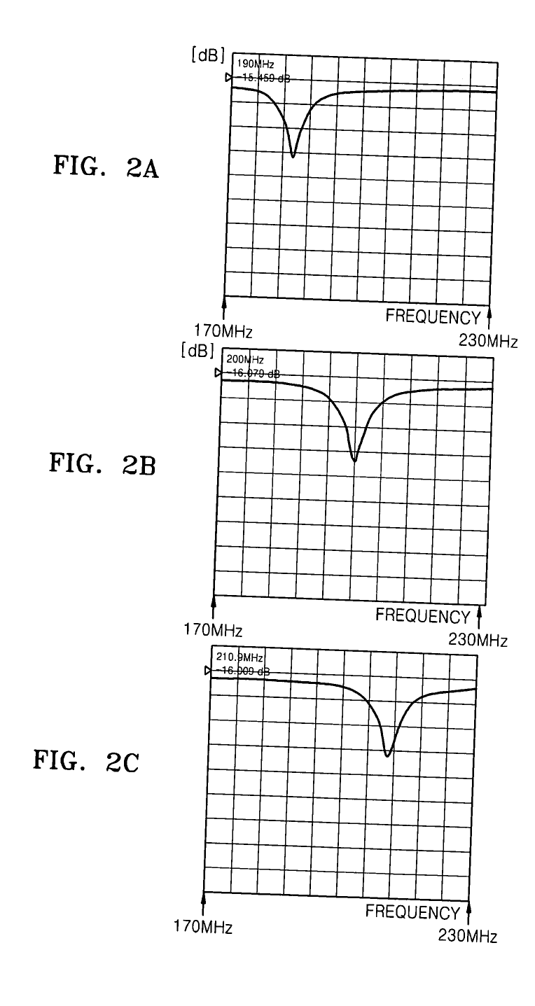

FIGS. 2A through 2C show transitions between frequency bands received by the antenna unit shown in FIG. 1. The frequency band shown in FIG. 1 extends from 170 MHz to 230 MHz, which is a frequency band in Band III. Referring to FIG. 2A, when the voltage value applied to the frequency band transition unit 110 via the helical unit 103 is 1V, the resonance circuit resonates at a resonance frequency that provides the antenna unit with an optimized receive sensitivity at 184.5 MHz in a frequency band received by the antenna unit. Referring to FIG. 2B, when the voltage value applied to the frequency band transition unit 110 via the helical unit 103 is 2V, the resonance circuit resonates at a resonance frequency that provides the antenna unit with an optimized receive sensitivity at 200 MHz in a frequency band received by the antenna unit. Referring to FIG. 2C, when the voltage value applied to the frequency band transition unit 110 via the helical unit 103 is 3V, the resonance circuit resonates at a frequency that provides the antenna unit with an optimized receive sensitivity at 210.9 MHz in a frequency band received by the antenna unit.

For example, when the antenna unit is to receive a channel 7 having a frequency of 184.5 MHZ, the voltage value applied to the antenna unit is 1V. The voltage value of 1V causes the antenna unit to receive a frequency band having the characteristics shown in FIG. 2A with an optimized receive sensitivity at the frequency of channel 7, i.e., at 184.5 MHz. When the antenna unit is to receive a channel 9 having a frequency of 200 MHz, the voltage value applied to the antenna unit is 2V. The voltage value of 2V causes the antenna unit to receive a frequency band having the characteristics shown in FIG. 2B with an optimized receive sensitivity at the frequency of channel 9, i.e., at 200 MHz. When the antenna unit is to receive a channel 11 having a frequency of 210.9 MHz, the voltage value applied to the antenna unit is 3V. The voltage value of 3V causes the antenna unit to receive a frequency band having the characteristics shown in FIG. 2C with an optimized receive sensitivity at the frequency of channel 11, i.e., at 210.9 MHz.

The antenna unit transitions between frequency bands having an optimized receive sensitivity according to established channels, thereby having an optimized receive sensitivity at every channel covered by the antenna unit.

The frequency band transition unit 110 outputs a signal through the helical antenna 103. The signal output from the helical antenna 103 is the signal received by the antenna unit of FIG. 1.

The antenna unit shown in FIG. 1 is applied to broadcasting in Band III, but the invention is not limited to this. The antenna unit can be applied to broadcasting in a UHF band or other frequency bands.

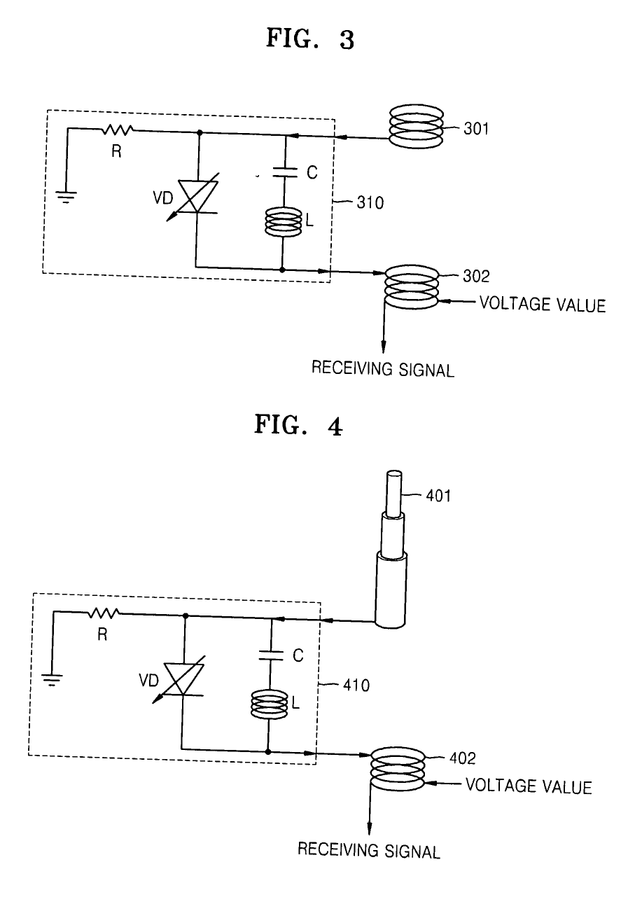

FIG. 3 shows an antenna unit according to another aspect of the invention. Referring to FIG. 3, the antenna unit includes two helical antennas 301 and 302, and a frequency band transition unit 310 interposed between the two helical antennas 301 and 302.

The constitution of the frequency band transition unit 310 is the same as the frequency band transition unit 110 shown in FIG. 1. The frequency band transition unit 310 transitions between frequency bands receivable by the two helical antennas 301 and 302 according to channels based on voltage values corresponding to the channels applied to the frequency band transition unit 310 via the helical antenna 302. The voltage values are different from one another according to the channels.

FIG. 4 shows an antenna unit according to another aspect of the invention. Referring to FIG. 4, the antenna unit includes a rod antenna 401, a helical antenna 402, and a frequency band transition unit 410 interposed between the rod antenna 401 and the helical antenna 402.

The constitution of the frequency band transition unit 410 is the same as the frequency band transition unit 110 shown in FIG. 1. The frequency band transition unit 410 transitions between frequency bands receivable by the rod antenna 401 and the helical antenna 402 according to channels based on voltage values corresponding to the channels applied to the frequency band transition unit 410 via the helical antenna 402. The voltage values are different from one another according to the channels.

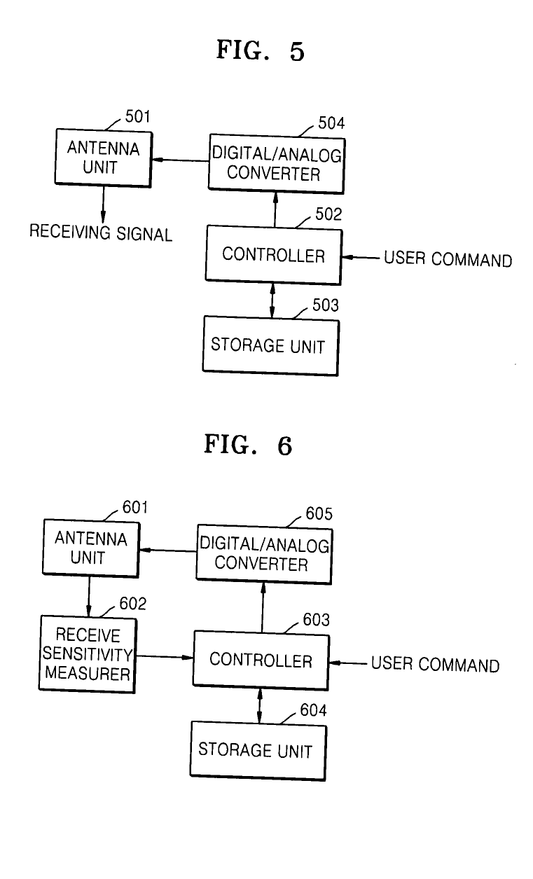

FIG. 5 is a block diagram of a mobile device including an antenna unit 501 according to an aspect of the invention. Referring to FIG. 5, the mobile device includes the antenna unit 501, a controller 502, a storage unit 503, and a digital/analog converter 504.

The antenna unit 501 can be one of the antenna units shown in FIGS. 1, 3, and 4. Therefore, the antenna unit 501 includes at least two antennas and can transition between frequency bands receivable by the antenna unit 501 according to channels based on voltage values corresponding to the channels provided by the digital/analog converter 504. A receiving signal output by the antenna unit 501 has an optimized receive sensitivity according to the channels.

If a user's command selecting a specific channel is input into the controller 502, the controller 502 provides a voltage value corresponding to the specific channel to the digital/analog converter 504. In detail, if the user's command selecting the specific channel is input into the controller 502, the controller 502 reads the voltage value corresponding to the specific channel from the storage unit 503, and provides the voltage value read from the storage unit 503 to the digital/analog converter 504.

The digital/analog converter 504 converts the voltage value provided by the controller 502 into an analog voltage value and outputs the analog voltage value to the antenna unit 501.

The voltage values corresponding to the channels are stored in the storage unit 503 for use in controlling the antenna unit to transition between the frequency bands receivable by the antenna unit 501 according to channels. If the mobile device can select ten channels, ten voltage values are stored in the storage unit 503. If the user's command requires auto tuning of channels selected by the mobile device, the controller 502 reads the voltage values corresponding to channels automatically selected according to a predetermined sequence from the storage unit 503, and outputs the voltage values to the digital/analog converter 504.

FIG. 6 is a block diagram of a mobile device including an antenna unit 601 according to another aspect of the invention. Referring to FIG. 6, the mobile device includes the antenna unit 601, a receive sensitivity measurer 602, a controller 603, a storage unit 604, and a digital/analog converter 605.

The constitution and operation of the antenna unit 601, the storage unit 604, and the digital/analog converter 605 are the same as the antenna unit 501, the storage unit 503, and the digital/analog converter 504 shown in FIG. 5.

The receive sensitivity measurer 602 measures a bit error rate (BER) of a signal output by the antenna unit 601, and outputs the measured BER to the controller 603 as a receive sensitivity of the signal.

The receive sensitivity measurer 602 can be defined as a receiver that receives the signal output by the antenna unit 601. If the receive sensitivity measurer 602 is the receiver, the receiver can measure the receive sensitivity of the signal output by the antenna unit 601.

The controller 603 determines whether the receive sensitivity of the signal provided by the receive sensitivity measurer 602 is optimized based on a predetermined receive sensitivity. If the BER provided as the receive sensitivity of the signal is close to a predetermined receive sensitivity of 0, the controller 603 determines that the receive sensitivity of the signal provided by the receive sensitivity measurer 602 is optimized. If the BER is not close to the predetermined receive sensitivity of 0, the controller 603 determines that the receive sensitivity of the signal provided by the receive sensitivity measurer 602 is not optimized. The controller 603 can use a value other than the predetermined receive sensitivity of 0 to determine whether the receive sensitivity of the signal provided by the receive sensitivity measurer 602 is optimized.

If the receive sensitivity of the signal provided by the receive sensitivity measurer 602 is not optimized, the controller 603 changes the voltage value of a channel stored in the storage unit 604 based on a predetermined rule. For example, if the voltage value of the channel stored in the storage unit 604 is 1V, and the predetermined rule provides that the voltage value is to be changed by +0.5V and −0.5V, the controller 603 changes the voltage value 1V of the channel to 1.5V (i.e., 1V+0.5V), and outputs the changed voltage value of 1.5V to the digital/analog converter 605.

The changed voltage value of 1.5V is changed to an analog voltage value and provided to the antenna unit 601 so that a frequency band received by the antenna unit 601 can be modified according to the analog voltage value. The antenna unit 601 outputs the signal received with the modified frequency band, and the receive sensitivity measurer 602 measures the receive sensitivity of the signal again and outputs the measured receive sensitivity to the controller 603.

If the measured receive sensitivity is still not optimized, the controller 603 changes the voltage value 1V of the channel to 0.5V (i.e., 1V-0.5V), and outputs the changed voltage value of 0.5V to the digital/analog converter 605.

The controller 603, the digital/analog converter 605, the antenna unit 601, and the receive sensitivity measurer 602 repeatedly perform an operation of changing the voltage value of the channel and measuring the receive sensitivity of the signal until the controller 603 determines that the receive sensitivity of the channel is optimized. The changed voltage value corresponding to the channel depends on the predetermined rule.

However, the number of times the receive sensitivity of the signal is measured can be limited to a predetermined number of times. In this case, the controller 603 controls the receive sensitivity measurer 602 to repeatedly measure the receive sensitivity of the signal until the controller 603 determines that the receive sensitivity of the signal is optimized or the receive sensitivity measurer 602 has measured the receive sensitivity of the signal the predetermined number of times, whichever comes first. The controller 603 changes the voltage value corresponding to the channel each time the receive sensitivity measurer 602 measures the receive sensitivity of the signal. If the controller 603 determines that the receive sensitivity of the signal is optimized before the receive sensitivity measurer 602 has measured the receive sensitivity of the signal the predetermined number of times, the controller 603 stops controlling the receive sensitivity measurer 602 to measure the receive sensitivity of the signal. However, if the controller 603 still has not determined that the receive sensitivity of the signal is optimized by the time the receive sensitivity measurer 602 has measured the receive sensitivity of the signal the predetermined number of times, thereby obtaining a predetermined number of measured receive sensitivities of the signal, the controller 603 sets an optimized receive sensitivity of the signal to be one of the predetermined number of measured receive sensitivities of the signal that is closest to the predetermined receive sensitivity.

If the receive sensitivity of the signal has been determined to be optimized or that the optimized receive sensitivity of the signal has been set, the controller 603 changes the voltage value corresponding to the channel stored in the storage unit 604 to a voltage value that was being used when the receive sensitivity of the signal was determined to be optimized or when the optimized receive sensitivity of the signal was set. If the voltage value that was being used is the same as the voltage value stored in the storage unit 604, the controller 603 does not change the voltage value corresponding to the channel stored in the storage unit 604.

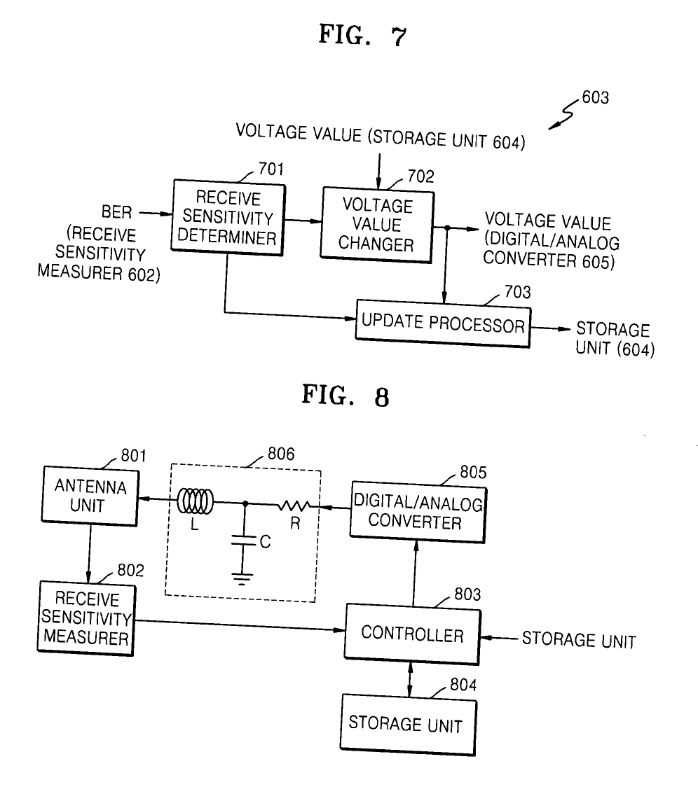

FIG. 7 is a block diagram of the controller 603 shown in FIG. 6. Referring to FIG. 7, the controller 603 includes a receive sensitivity determiner 701, a voltage value changer 702, and an update processor 703.

The receive sensitivity determiner 701 receives a BER of a signal from the receive sensitivity measurer 602, and determines whether a receive sensitivity of the signal is optimized based on a predetermined receive sensitivity. The predetermined receive sensitivity can be set to 0 or some other value as described above in connection with FIG. 6. The receive sensitivity determiner 701 can determine whether the receive sensitivity of the signal is optimized based on no more than a predetermined number of measurements of the receive sensitivity of the signal as described above in connection with FIG. 6.

If the receive sensitivity determiner 701 determines that the receive sensitivity of the signal is not optimized, the receive sensitivity determiner 701 requests the voltage value changer 702 to change the voltage values being used. The voltage value changer 702 reads voltage values corresponding to channels stored in the storage unit 604, changes the read voltage values based on a predetermined rule as described above in connection with FIG. 6, and outputs the changed voltage values to the digital/analog converter 605 and the update processor 703.

The digital/analog converter 605 converts the voltage values received from the voltage value changer 702 into analog voltage values, and provides the analog voltage values to the antenna unit 601.

The update processor 703 manages the voltage values changed by the voltage value changer 702. If the receive sensitivity determiner 701 informs the update processor 703 that the receive sensitivity of the signal has been determined to be optimized or that the optimized receive sensitivity of the signal has been set, the update processor 703 updates the voltage value corresponding to the channel stored in the storage unit 604 to a voltage value that was being used when the receive sensitivity of the signal was determined to be optimized or when the optimized receive sensitivity of the signal was set if the two voltage values are different from one each other. That is, the update processor 703 compares the voltage value corresponding to the channel stored in the storage unit 604 with the voltage value that was being used when the receive sensitivity of the signal was determined to be optimized or when the optimized receive sensitivity of the signal was set. If the two voltage values are identical to each other, the update processor 703 does not update the voltage value corresponding to the channel stored in the storage unit 604.

FIG. 8 is a block diagram of a mobile device including an antenna unit 801 according to still another aspect of the invention. Referring to FIG. 8, the mobile device includes the antenna unit 801, a receive sensitivity measurer 802, a controller 803, a storage unit 804, a digital/analog converter 805, and a receiving signal blocker 806.

The constitution and operation of the antenna unit 801, the receive sensitivity measurer 802, the controller 803, the storage unit 804, and the digital/analog converter 805 are the same as the antenna unit 601, the receive sensitivity measurer 602, the controller 603, the storage unit 604, and the digital/analog converter 605 shown in FIG. 6.

The receiving signal blocker 806 blocks a signal received by the antenna unit 801 from being transmitted to the digital/analog converter 805, but transmits an analog voltage value output by the digital/analog converter 805 to the antenna unit 801. The receiving signal blocker 806 includes a circuit in which an inductor L and a resistor R are connected in series at a junction point, and a capacitor C is connected between the junction point between the inductor L and the resistor R and a ground. Therefore, the signal received by the antenna unit 801 is prevented from being transmitted to the digital/analog converter 805 by the receiving signal blocker 806 so that the signal received by the antenna unit 801 is transmitted to the receive sensitivity measurer 802.

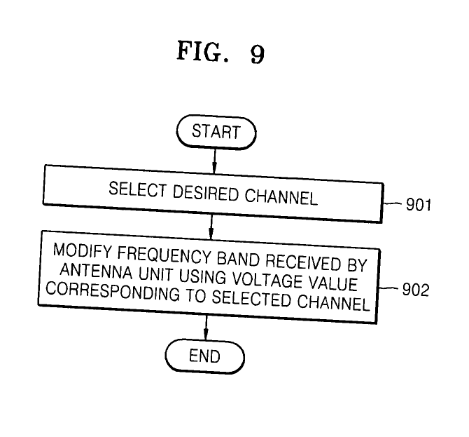

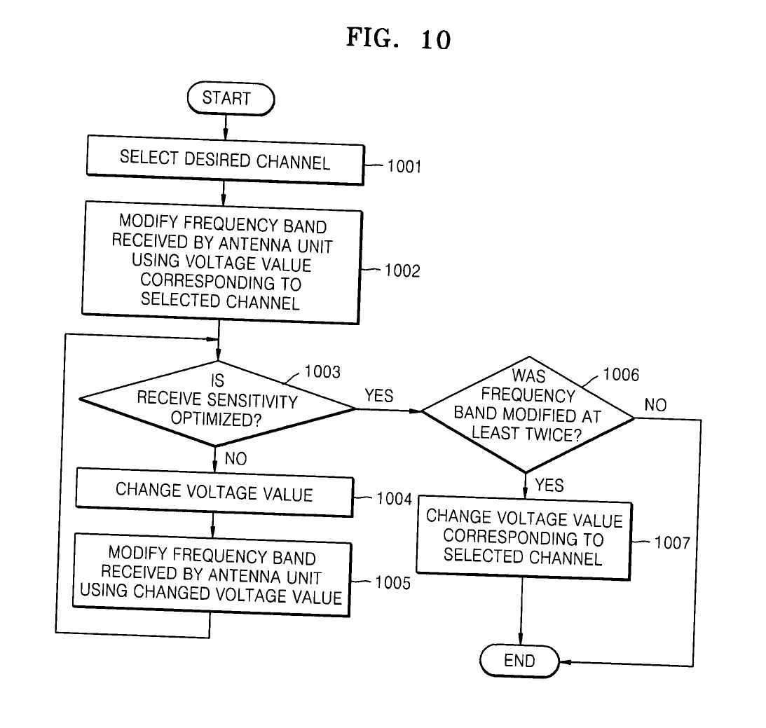

FIG. 9 is a flowchart of a method of controlling an antenna unit according to an aspect of the invention. Referring to FIG. 9, a channel to receive broadcasting is selected according to a user's command (block 901). A frequency band received by an antenna unit is modified using a voltage value corresponding to the selected channel (block 902), and the process ends.

The channel is selected by a user, or is automatically selected in response to a user's request for automatic tuning. The voltage value corresponding to the selected channel is a default voltage value corresponding to the selected channel. The frequency band received by the antenna unit is modified according to the voltage value corresponding to the selected channel as described, for example, in connection with any of the antenna units shown in FIGS. 1, 3, and 4.

FIG. 10 is a flowchart showing a method of controlling an antenna unit according to another aspect of the invention. Referring to FIG. 10, a channel to receive broadcasting is selected according to a user's command (block 1001). A frequency band received by an antenna unit is modified using a voltage value corresponding to the selected channel (block 1002). The voltage value corresponding to the selected channel is a default voltage value corresponding to the selected channel. The selection of the channel and the modification of the frequency band received by the antenna unit are the same as in the method shown in FIG. 9.

After the frequency band received by the antenna unit is modified, it is determined whether a receive sensitivity of a signal is optimized (block 1003) as described, for example, in connection with the receive sensitivity measurer 602 shown in FIG. 6 or the receive sensitivity measurer 802 shown in FIG. 8.

If it is determined that the receive sensitivity of the receiving signal is not optimized, a voltage value of the selected channel is changed based on a predetermined rule (block 1004) as described, for example, in connection with FIG. 6. The frequency band received by the antenna unit is modified using the changed voltage value (block 1005).

It is determined whether a receive sensitivity of another signal detected after modifying the frequency band received by the antenna unit is optimized (block 1003). If it is determined that the receive sensitivity of the signal is not optimized, the operations in blocks 1004 and 1005 are repeated.

If it is determined that the receive sensitivity of the signal is optimized, it is determined whether the frequency band received by the antenna unit was modified at least twice (block 1006). If it is determined that the frequency band received by the antenna unit was modified at least twice, the default voltage value corresponding to the selected channel is changed to be a voltage value used when it was determined that the receive sensitivity of the signal is optimized (block 1007), and the process ends.

If it is determined that the frequency band received by the antenna unit was not modified at least twice, this indicates that an optimized receive sensitivity was detected by modifying the frequency band received by the antenna unit only once using the default voltage value corresponding to the selected channel, and accordingly the default voltage value corresponding to the selected channel is not changed and the process ends.

The method of controlling the antenna unit according to an aspect of the invention described above includes repeatedly changing the voltage value corresponding to the selected channel and modifying the frequency band received by the antenna unit until it is determined that the receive sensitivity of the signal is optimized. However, the number of times that the voltage value corresponding to the channel is changed and the frequency band received by the antenna unit is modified can be limited to a predetermined number of times as described above in connection with FIG. 6. In this case, if it has not been determined that the receive sensitivity of the signal is optimized by the time the voltage value corresponding to the channel has been changed the predetermined number of times and the frequency band received by the antenna unit has been modified the predetermined number of times, an optimized receive sensitivity of the signal is set to be a receive sensitivity of the signal that is closest to the predetermined receive sensitivity among a predetermined number of receive sensitivities of the signal obtained when the frequency band received by the antenna unit was modified the predetermined number of times, and the voltage value corresponding to the selected channel is changed to be a voltage value used when the receive sensitivity of the signal that is closest to the predetermined receive sensitivity was obtained.

The methods shown in FIGS. 9 and 10 use a single channel. However, the methods shown in FIGS. 9 and 10 can use channels selected in an automatic tuning mode by a mobile device according to an aspect of the invention.

An aspect of the invention is to provide an antenna unit using a short antenna that covers a wide frequency band relative to a channel bandwidth by transitioning between frequency bands receivable by the antenna unit according to selected channels, and a mobile device including the antenna unit that receives broadcasting.

Another aspect of the invention is to provide an antenna unit that covers a wide frequency band relative to a channel bandwidth by changing default voltage values used to transition between frequency bands receivable by the antenna unit according to channels based on a BER of a signal received by the antenna unit, and a mobile device including the antenna unit that receives broadcasting.

Although various embodiments of the invention have been shown and described, it would be appreciated by those skilled in the art that changes may be made in these embodiments without departing from the principles and spirit of the invention, the scope of which is defined in the claims and their equivalents.

What is claimed is:

1. An antenna unit comprising:
a first antenna;
a second antenna receiving an electrical signal from the first antenna; and
a frequency band transition unit interposed between the first antenna and the second antenna and transitioning between frequency bands receivable by the first antenna and the second antenna according to channels.

2. The antenna unit of claim 1, wherein the frequency band transition unit transitions between the frequency bands based on voltage values corresponding to the channels applied to the frequency band transition unit.

3. The antenna unit of claim 2, wherein the frequency band transition unit comprises a resonance circuit.

4. The antenna unit of claim 3, wherein the resonance circuit comprises:
an input terminal connected to the first antenna;
an output terminal connected to the second antenna;
a junction point;
a ground;
a capacitor connected between the input terminal and the junction point;
an inductor connected between the junction point and the output terminal;
a voltage-controlled capacitor connected between the input terminal and the output terminal; and
a resistor connected between the input terminal and the ground.

5. The antenna unit of claim 4, wherein the voltage-controlled capacitor comprises a varactor diode.

6. The antenna unit of claim 4, wherein the voltage values corresponding to the channels applied to the frequency band transition unit control a capacitance of the voltage-controlled capacitor, thereby controlling a resonance frequency of the resonance circuit.

7. The antenna unit of claim 3, wherein the first antenna is a rod antenna and the second antenna is a helical antenna.

8. The antenna unit of claim 3, wherein the first antenna is a first helical antenna and the second antenna is a second helical antenna.

9. The antenna unit of claim 1, wherein the first antenna is a rod antenna and the second antenna is a helical antenna.

10. The antenna unit of claim 1, wherein the first antenna is a first helical antenna and the second antenna is a second helical antenna.

11. An antenna unit comprising:
a first antenna;
a second antenna connected to the first antenna and receiving an electrical signal from the first antenna;
a third antenna receiving an electrical signal from the second antenna; and
a frequency band transition unit interposed between the second antenna and the third antenna and transitioning between frequency bands receivable by the first antenna, the second antenna, and the third antenna according to channels.

12. The antenna unit of claim 11, wherein the first antenna is a rod antenna, the second antenna is a first helical antenna, and the third antenna is a second helical antenna.

13. The antenna unit of claim 11, wherein the first helical antenna is a traveling-wave antenna.

14. A mobile device comprising:
an antenna unit comprising;
at least two antennas; and
a frequency band transition unit interposed between two of the at least two antennas and transitioning between frequency bands receivable by the antenna unit according to channels;
a storage unit storing voltage values corresponding to the channels for use in controlling the antenna unit to transition between the frequency bands receivable by the antenna unit according to the channels;
a controller outputting the voltage values corresponding to the channels based on the voltage values corresponding to the channels stored in the storage unit; and
a digital/analog converter converting the voltage values corresponding to the channels output by the controller into analog voltage values corresponding to the channels and providing the analog voltage values corresponding to the channels to the antenna unit.

15. The mobile device of claim 14, further comprising a receive sensitivity measurer measuring a receive sensitivity of a signal received by the antenna unit while the digital/analog converter is providing one of the analog voltage values corresponding to one of the channels to the antenna unit, and providing the receive sensitivity of the signal to the controller;
wherein the controller determines whether the receive sensitivity of the signal is optimized; and
wherein if the controller determines that the receive sensitivity of the signal is not optimized, the controller repeatedly changes one of the voltage values corresponding to the one of the channels that was output by the controller and converted by the digital/analog converter into the one of the analog voltage values corresponding to the one of the channels and provides the changed voltage value to the analog/digital converter until the controller determines that the receive sensitivity of the signal is optimized.

16. The mobile unit of claim 15, wherein the receive sensitivity measurer measures a bit error rate of the signal as the receive sensitivity of the signal, and provides the bit error rate to the controller; and
wherein the controller determines whether the receive sensitivity of the signal is optimized by comparing the bit error rate of the signal with a predetermined bit error rate corresponding to a predetermined receive sensitivity of the signal.

17. The mobile unit of claim 15, wherein the controller repeatedly changes the one of the voltage values corresponding to the one of the channels that was output by the controller and converted by the digital/analog converter into the one of the analog voltage values corresponding to the one of the channels according to a predetermined rule.

18. The mobile unit of claim 15, wherein if a voltage value corresponding to the one of the channels being output from the controller and converted by the analog/digital converter into an analog voltage value at a time when the controller determines that the receive sensitivity of the signal is optimized is different from a voltage value corresponding to the one of the channels stored in the storage unit, the controller changes the voltage value corresponding to the one of the channels stored in the storage unit to the voltage value corresponding to the one of the channels being output from the controller and converted by the analog/digital converter into an analog voltage value at the time when the controller determines that the receive sensitivity of the signal is optimized.

19. The mobile unit of claim 18, wherein a frequency band receivable by the antenna unit corresponding to the one of the channels is modified each time the controller outputs a voltage value;
wherein the controller determines a number of times the frequency band receivable by the antenna unit corresponding to the one of the channels has been modified; and
wherein if the controller determines that the frequency band receivable by the antenna unit corresponding to the one of the channels has been modified at least twice, the controller
determines that the voltage value corresponding to the one of the channels being output from the controller and converted by the analog/digital converter into an analog voltage value at the time when the controller determines that the receive sensitivity of the signal is optimized is different from the voltage value corresponding to the one of the channels stored in the storage unit, and changes the voltage value corresponding to the one of the channels stored in the storage unit to the voltage value corresponding to the one of the channels being output from the controller and converted by the analog/digital converter into an analog voltage value at the time when the controller determines that the receive sensitivity of the signal is optimized

20. The mobile device of claim 14, further comprising a receive sensitivity measurer measuring a receive sensitivity of a signal received by the antenna unit while the digital/analog converter is providing one of the analog voltage values corresponding to one of the channels to the antenna unit, and providing the receive sensitivity of the signal to the controller;
wherein the controller determines whether the receive sensitivity of the signal is optimized based on a predetermined receive sensitivity;
wherein if the controller determines that the receive sensitivity of the signal is not optimized, the controller repeatedly changes one of the voltage values corresponding to the one of the channels that was output by the controller and converted by the digital/analog converter into the one of the analog voltage values corresponding to the one of the channels and provides the changed voltage value to the analog/digital converter until the controller determines that the receive sensitivity of the signal is optimized or until the receive sensitivity measurer has measured the receive sensitivity of the signal a predetermined number of times to obtain a predetermined number of measured receive sensitivities, whichever comes first; and
wherein if the controller has not determined that the receive sensitivity of the signal is optimized by a time the receive sensitivity measurer has measured the receive sensitivity of the signal the predetermined number of times, the controller sets an optimized receive sensitivity of the signal to be one of the predetermined number of measured receive sensitivities that is closest to the predetermined receive sensitivity.

21. The mobile device of claim 20, wherein if a voltage value corresponding to the one of the channels being output from the controller and converted by the analog/digital converter into an analog voltage value at a time when the controller either determines that the receive sensitivity of the signal is optimized or sets the optimized receive sensitivity of the signal is different from a voltage value corresponding to the one of the channels stored in the storage unit, the controller changes the voltage value corresponding to the one of the channels stored in the storage unit to the voltage value corresponding to the one of the channels being output from the controller and converted by the analog/digital converter into an analog voltage value at the time when the controller either determines that the receive sensitivity of the signal is optimized or sets the optimized receive sensitivity.

22. The mobile device of claim 20, further comprising a receive signal blocker blocking a signal received by the antenna unit from being transmitted to the digital/analog converter.

23. The mobile device of claim 14, further comprising a receive signal blocker blocking a signal received by the antenna unit from being transmitted to the digital/analog converter.

24. A method of controlling an antenna unit in a mobile device, the method comprising:
selecting a channel; and
modifying a frequency band being received by the antenna unit based on a voltage value corresponding to the selected channel.

25. The method of claim 24, wherein the modifying of the frequency band being received by the antenna unit comprises applying the voltage value corresponding to the selected channel to the antenna unit to modify the frequency band being received by the antenna unit.

26. The method of claim 25, further comprising:
determining whether a receive sensitivity of a signal being received by the antenna unit is optimized;
if a determination is made that the receive sensitivity of the signal being received by the antenna unit is not optimized, repeatedly changing the voltage value based on which the frequency band being received by the antenna unit is being modified, modifying the frequency band being received by the antenna unit based on the changed voltage value, and performing the determining of whether a receive sensitivity of a signal being received by the antenna unit is optimized until a determination is made that the receive sensitivity of the signal being received by the antenna unit is optimized; and
if the changed voltage value at a time when the determination is made that the receive sensitivity of the signal being received by the antenna unit is optimized is different from the voltage value corresponding to the selected channel, changing the voltage value corresponding to the selected channel to be the changed voltage value at the time when the determination is made that the receive sensitivity of the signal being received by the antenna unit is optimized.

27. The method of claim 24, further comprising:
determining whether a receive sensitivity of a signal being received by the antenna unit is optimized;
if a determination is made that the receive sensitivity of the signal being received by the antenna unit is not optimized, repeatedly changing the voltage value based on which the frequency band being received by the antenna unit was modified, modifying the frequency band being received by the antenna unit based on the changed voltage value, and performing the determining of whether a receive sensitivity of a signal being received by the antenna unit is optimized until a determination is made that the receive sensitivity of the signal being received by the antenna unit is optimized; and
if the changed voltage value at a time when the determination is made that the receive sensitivity of the signal being received by the antenna unit is optimized is different from the voltage value corresponding to the selected channel, changing the voltage value corresponding to the selected channel to be the changed voltage value at the time when the determination is made that the receive sensitivity of the signal being received by the antenna unit is optimized.

28. The method of claim 24, further comprising:
determining whether a receive sensitivity of a signal being received by the antenna unit is optimized based on a predetermined receive sensitivity;
if a determination is made that the receive sensitivity of the signal being received by the antenna unit is not optimized, repeatedly changing the voltage value based on which the frequency band being received by the antenna unit was modified, modifying the frequency band being received by the antenna unit based on the changed voltage value, and performing the determining of whether a receive sensitivity of a signal being received by the antenna unit is optimized until a determination is made that the receive sensitivity of the signal being received by the antenna unit is optimized or until the determining of whether a receive sensitivity of the signal being received by the antenna unit is optimized has been performed a predetermined number of times based on a predetermined number of receive sensitivities of the signal being received by the antenna unit, whichever comes first;
if a determination has not been made that the receive sensitivity of the signal being received by the antenna unit is optimized by a time the determining of whether a receive sensitivity of the signal being received by the antenna unit is optimized has been performed the predetermined number of times, setting an optimized receive sensitivity of the signal being received by the antenna unit to be one of the predetermined number of receive sensitivities of the signal being received by the antenna unit that is closest to the predetermined receive sensitivity; and
if the changed voltage value at a time when the determination is made that the receive sensitivity of the signal being received by the antenna unit is optimized or the optimum receive intensity of the signal being received by the antenna unit is set is different from the voltage value corresponding to the selected channel, changing the voltage value corresponding to the selected channel to be the changed voltage value at the time when the determination is made that the receive sensitivity of the signal being received by the antenna unit is optimized or the optimum receive intensity of the signal being received by the antenna unit is set.
